(19) United States
(12) Patent Application Publication
(10) Pub. No.: US 2017/0163918 A1
(43) Pub. Date: Jun. 8, 2017

(54) IMAGE CAPTURING DEVICE AND METHOD

(71) Applicant: TINYMOS PRIVATE LIMITED, Singapore (SG)

(72) Inventors: Junyang CHEN, Singapore (SG); Lih Wei CHIA, Singapore (SG); Ashprit Singh ARORA, Singapore (SG)

(73) Assignee: TINYMOS PRIVATE LIMITED, Singapore (SG)

(21) Appl. No.: 15/328,014

(22) PCT Filed: Jul. 21, 2015
(86) PCT No.: PCT/SG2015/050221

§ 371 Date: Jan. 20, 2017

(30) Foreign Application Priority Data
Jul. 21, 2014 (SG) 10201404272X

(51) Int. Cl. H04N 5/361; H04N 5/225; H04N 5/232; H04N 5/217

(52) U.S. Cl. CPC H04N 5/361; H04N 5/2178; H04N 5/2254; H04N 5/23212; H04N 5/23222; H04N 5/23293

(57) ABSTRACT

An image capturing apparatus comprising an optical lens operable to focus incoming light; a focal reducer arranged to receive focused incoming light from the optical lens and concentrate the focused incoming light onto an image sensor; a processer in data communication with the image sensor to process the concentrated light to form an image; wherein the processor comprises a noise reduction module operable to remove noise from the image, is disclosed.

### FIELD OF THE INVENTION

The present invention relates to an image-capturing device. The image-capturing device is suited (but not limited) for capturing astronomical images and will be described in such context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Astronomy is a hobby that is quickly gaining popularity with the availability of cameras and other equipment, especially digital cameras. However, astronomy products are generally heavy, complex and difficult to use. In particular, in order to properly capture images of relatively ‘dim’ astronomical objects, the camera lenses used are typically large telephotos, telescopes or heavy and expensive large aperture prime lenses, coupled with complex scientific imaging sensors or professional grade digital single-lens reflex cameras (DSLRs).

The atypical image backdrop of an astronomy image means the metering mechanism (or metering mode) of typical cameras tuned for terrestrial use is incompatible. This necessitates the manual adjustment of various settings of the camera and its accessories, adding to its complexity and difficulty in use. Further, the level of expertise required and the high cost of the equipment have led to astronomy not being as popular as it should be.

Due to benefits associated with a larger crop factor, the use of a webcam to capture astronomy images is one attempted solution to reduce the cost of telephoto optics and size of the equipment used. However, the imaging process remains complicated. Furthermore, the use of a webcam requires a processor such as a laptop to operate, adding to the weight, cost and complexity of the process. In addition, images captured by a webcam tend to have a high level of noise, especially if the gain or exposure length is increased for distant celestial objects. The captured images therefore require additional niche knowledge for the application of noise reduction measures to improve image quality

In light of the above, astronomical imaging is limited to specialised niche groups due to three (3) key factors: weight, cost and complexity.

The present invention seeks to provide an apparatus that alleviates the above mentioned drawbacks at least in part.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

It is to be appreciated that the following terms “ISO”, “Gain”, and “Sensitivity” referred to throughout the document relates to parameters for imaging, and may be utilized for amplification of a signal from an imaging sensor. Such amplification may be achieved based on hardware or software means. The higher the setting of these parameters, the more sensitive an imaging capturing apparatus is to light, at the trade-off of having higher noise in the final image.

An objective of the invention is to reduce the limitations due to all three (3) key factors mentioned in the prior art section, so as to make astronomy imaging light, affordable and less complex. This allows the exploration of astronomy by amateurs, travelers and students far more easily as it is financially more accessible, more portable and less complicated.

The above and other problems are mitigated and an improvement in the art is made by an apparatus in accordance with the present invention. The following advantages are non-exhaustive. A first advantage of the apparatus in accordance with this invention is that users are able to quickly and easily capture astronomical images that are clear, particularly for astronomy or celestial objects. The compact imaging device is user friendly and contains features such as focal reducers and on-board imaging processing software. The focal reducers may be in-built so as to achieve space-savings and reduction of form factor of the camera. The focal reducers are further operable to simultaneously concentrate light to the imaging sensor, and therefore provide an improvement in light collection by the imaging sensor, thereby improving signal to noise ratio of the captured image.

A second advantage of the apparatus in accordance with this invention is that users are able to obtain high quality astronomical images, via imaging presets, which enables imaging of such objects through a menu selection, rather than manually controlling all aspects of the capturing process. This allows for easy capturing of astronomical images without the need for additional hardware or expertise. A third advantage of the apparatus in accordance with this invention is that users are able to identify stars and other celestial objects at the point of capture easily with the star maps overlay. The live preview, in conjunction with the star maps overlay, allows users to frame their preferred stars and other celestial objects accordingly. A fourth advantage of the apparatus in accordance with this invention is that users are able to quickly and accurately identify and locate bright objects to focus on. This functionality is important to shorten the learning curve of astronomy imaging, as the objects photographed are typically dim and difficult to focus on, especially if the user has no prior knowledge of the stars and their relative directions. The on-board processor is able to adjust and calibrate accordingly for the user to do so by referencing an on-board star atlas and its spatial sensors.

In accordance with an aspect of the invention there is an imaging system having:—an image capturing apparatus comprising a primary lens, the image capturing apparatus having a built-in focal reducer operable to focus an image captured by the primary lens to a smaller area; a processor operable to receive location-based data to guide a user of the image capturing apparatus to point the image capturing apparatus at an object for focusing the image capturing apparatus prior to capturing an image.

Preferably, the built-in focal reducer is operable to achieve a pre-determined increase in the intensity of light provided or projected on the sensor. The arrangement projects an increase of about ⅕ times more light onto the imaging sensor, and it may increase up to about 4 times more light when DSLR lens are used as primary objectives.

Preferably, the intensity of light is measured by the focal ratio of the lens/lens system. In this regard, the focal reducer will increase the focal ratio by at least one ⅔ stops for lenses designed for Single Lens Reflex cameras and may be more or less for imaging lenses originally designed for other purposes.

Said focal ratio allows a reduction in gain or exposure length or both, which improves image quality by reducing noise in the final image.

Preferably the location-based data comprises a star maps overlay of at least one star chart. Such a star chart allows users to easily identify stars or other celestial objects at the point of capture to ensure proper framing of the objects users want to capture.

Preferably, the image capturing apparatus comprises an interchangeable sensor filter, the sensor filter suited for astronomical imaging purpose by eliminating common light pollution spectrums, such as the mercury or sodium lines.

Preferably the system comprises a dark noise database, the dark noise database comprising dark noise images calibrated specific to the image capturing apparatus for the purpose of dark noise subtraction. Such an arrangement saves time required at the point of capture compared to prior art cameras, allowing greater amount of image capturing time.

In accordance with another aspect of the invention there is an image capturing apparatus comprising: an optical lens operable to focus incoming light; a focal reducer arranged to receive focused incoming light from the optical lens and concentrate the focused incoming light onto an image sensor; a processer in data communication with the image sensor to process the concentrated light to form an image; wherein the processor comprises a noise reduction module operable to remove noise from the image.

Preferably, the focal reducer is integrable with the optical lens and the image sensor.

Preferably, the intensity of the concentrated focused incoming light is determined by a focal ratio of the lens system and the focal ratio allows a reduction in gain or exposure length or both.

Preferably, the image sensor comprises of an array of pixel sensors. The array of pixel sensors may be a charge-coupled device (CCD) or a Complementary metal-oxide semiconductor (CMOS) sensor.

Preferably, the processor is operable to store the image.

Preferably, the apparatus further comprises a sensor filter, wherein the sensor filter is operable to filter the incoming light.

Preferably, the noise reduction module comprises a database of dark noise images pre-captured and stored in the database. The noise reduction may comprise a selection of a dark noise image having similar exposure settings as the image and pixel subtracting the dark noise image from the image. The similar exposure settings may include environmental settings, and the environmental settings may include duration of capture and sensor temperature.

Preferably, a plurality of noise-reduced images are combined into one resultant image to further reduce noise.

Preferably, the noise reduction module is operable to combine a plurality of images.

Preferably, the processor further comprises an image live view module operable to display the live image and assist the user in the focusing and capturing of image. The image live view function may further comprise a built-in display screen in data communication with the processor. The apparatus may further comprise a star atlas chart operable to be overlaid over the live image to assist the user identify the objects the apparatus is pointing at, in real time.

Preferably, the built-in display screen is a touch screen operable to allow touch inputs to control image capturing settings.

Preferably, the apparatus further comprises a plurality of spatial sensors in data communication with the processor to provide location input, wherein each spatial sensor is operable to assist a user point the apparatus at a desired object for image capture.

Preferably, the plurality of spatial sensors comprises at least one of the following:—a Global Positioning System (GPS), accelerometer, gyroscope and magnetometer. Alternatively, the spatial sensor comprises a Global Positioning System (GPS), an accelerometer, and a magnetometer.

Preferably, the processor further comprises a bright object focus module operable to assist the user quickly identify, locate and focus on bright objects.

The bright object focus module may comprise the following functions:—

(i) determine time and spatial orientation function;

(ii) generate a bright object list function; and

(iii) a guidance function.

The determine time and spatial orientation function may be operable to determine at least three parameters for the purpose of identifying one or more bright objects, the at least three parameters comprises a reference to the real time clock (RTC) for date and time, reference to GPS coordinates to determine location, date and time; and a reference to a plurality of spatial sensor for direction.

The generate bright object list function may be operable to use the at least three parameters and refer to a star atlas database to identify objects or stars above horizon and placing them in a bright object list.

Preferably, the bright object list can be sorted according to at least one criterion.

Preferably, the guidance function is operable to display the bright object list and display a pointer to guide the user to select a bright object on the list.

Preferably, the apparatus further comprises a variable intervalometer in data communication with the processor, wherein the intervalometer is operable to assist a user capture time-lapse images with variable time intervals between adjacent images; and the time intervals are pre-programmable.

Preferably, the apparatus further comprises an external connectivity module is coupled to the processor, the external connectivity module operable to interface with other electronic devices. The external connectivity module may include the Wi-Fi protocol or the Universal Serial Bus (USB).

In accordance with another aspect of the invention there is a method for capturing image comprising the steps of:—(i) focusing incoming light using an optical lens; (ii) concentrating the focused incoming light onto an image sensor using a focal reducer; (iii) processing the focused incoming light using a processor to form an image; wherein the processor is further operable to perform the step of subtracting noise from the image using a noise reduction module.

Preferably, the noise reduction module comprises a database of dark noise images pre-captured and stored in the database. Preferably, the method comprises a step of selecting a dark noise image having similar exposure settings as the image and pixel before subtracting the noise from the image.

The similar exposure settings may include environmental settings, and the environmental settings may include duration of capture and sensor temperature.

Preferably, a plurality of noise-reduced images are combined into one resultant image to further reduce noise.

Preferably, the noise reduction module is operable to combine a plurality of images.

### BRIEF DESCRIPTION OF THE DRAWINGS

The present invention will now be described, by way of example only, with reference to the accompanying drawings, in which:

FIG. 1 is system block diagram showing the image capturing apparatus and system in accordance with an embodiment of the invention;

FIGS. 2a, 2b, 2c and 2d are various views of a portion of the image capturing unit in accordance with the embodiment of FIG. 1;

FIG. 3 shows a flowchart of how an image is captured in accordance with another embodiment of the invention;

FIG. 4 illustrates the use of an image capturing apparatus and examples of the user-interface;

FIG. 5 illustrates a flowchart of a ‘point to bright object to focus’ in accordance with an embodiment of the invention; and

FIG. 6 illustrates the comparison between a prior art noise reduction with (i.) a speed priority noise reduction; or (ii.) a quality priority noise reduction in relation to dark library(ies).

Other arrangements of the invention are possible and, consequently, the accompanying drawings are not to be understood as superseding the generality of the preceding description of the invention.

### DETAILED DESCRIPTION OF THE INVENTION

Particular embodiments of the present invention will now be described with reference to the accompany drawings. The terminology used herein is for the purpose of describing particular embodiments only and is not intended to limit the scope of the present invention. Additionally, unless defined otherwise, all technical and scientific terms used herein have the same meanings as commonly understood by one or ordinary skill in the art to which this invention belongs.

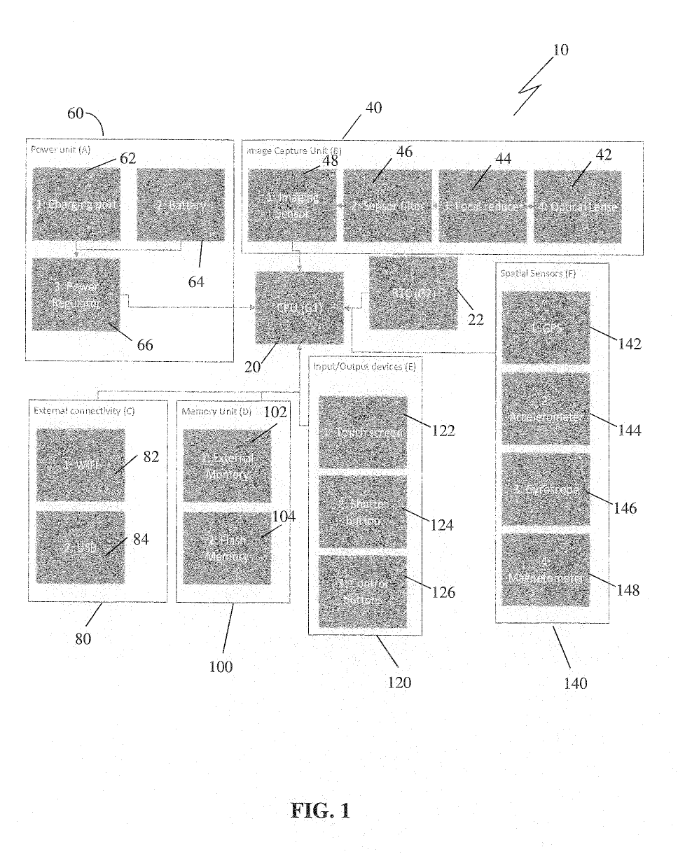

In accordance with an embodiment of the invention and as shown in FIG. 1 there is a system 10 for capturing images comprising a processor that may be in the form of a central processing unit (CPU) 20 operable to receive image from an image capture unit 40. The system 10 may be in the form of an image capturing apparatus such as a camera 10.

The camera 10 may be powered by a power unit 60 and may comprise external connectivity module 80 and memory unit 100. The apparatus 10 may further comprise an input/output (IO) module 120 arranged to allow a user to control the apparatus 10. The apparatus 10 further comprises spatial sensors 140 suitable for (but not limited to) assisting the apparatus 10 in assessing the spatial location and location-based applications. The modules 40, 60, 80, 100, 120 and 140 are operable to be in data communication with the CPU 20 for the sending and receiving of communication, control, input output (IO) and other electronic signals as known to a skilled person and will not be further elaborated.

The image capture unit 40 comprises hardware capable of capturing images, such as optical lens 42, focal reducer 44, and sensor filter 46. The optical lens 42 collects light from the environment to be focused on an imaging sensor 48. An example of the imaging sensor 48 may be (but not limited to) a Complementary metal-oxide semiconductor (CMOS), for saving the images into a digital image format, such as for example jpeg, tiff, tif or RAW formats. The focal reducer 44 is typically a removable positive lens element or a plurality of lens (i.e. a lens group) operable to converge (focus) light collected by the optical lens 42 to a small area. The primary purpose of the focal reducer 44 is to increase the intensity of light falling onto the imaging sensor 48 and hence enhances the ability of the light collecting property of imaging sensor 48. In addition, the focal reducer 44 widens the field of view of the optical lens 42 and imaging sensor pair 48. The focal reducer is operable to decrease the focal ratio (F number) of the optical lens 42. Preferably, the focal reducer is operable to at least increase the intensity of light by three (3) times or maximize the amount of light to be focused onto the imaging sensor to provide as much data as possible associated with image capture.

Focal reducers 44 may be a built-in component or a separate attachment.

The sensor filter 46 is typically a removable piece of optical glass. Depending on the application the sensor filter 46 may be an optical glass of various characteristics. For example, the glass can allow the transmission of H-alpha line (656.28 nanometres), or the emission line of excited hydrogen particle, and block the transmission of other wavelengths the imaging sensor 48 is sensitive to. The blocking of transmission of selected wavelengths allow the imaging of astronomy objects that are strong emitters of H-Alpha radiation, for example the Sun and various nebulas such as M42 Great Orion Nebula without interference from light pollution from earth's environment such as street lamps and fluorescent lamps used in buildings. Other sensor filters such as Oxygen III and Light Pollution filters can also be used to achieve similar purpose, depending on the condition and astronomical object being captured. In summary, the sensor filter 46 is at least one interchangeable sensor filter 46 suited for astronomical imaging purpose, and is operable to serve the purpose of filtering out light pollution, increase contrast or reveal structures in the celestial objects that would otherwise be washed out by the brighter spectrums of light without the filtering effects of the sensor filter. Such filters include, for example, H-Alpha, O-III and Light pollution filters. It is to be appreciated that the types of filters that may be used are non-exhaustive.

The power unit 60 is operable to provide electrical power to the entire camera system 10. The power unit 60 comprises a charging port 62 that is the junction where external electrical power is supplied to the device 10 to charge a power source such as a battery 64. The battery 64 is the primary source of power for the device 10 when used as a standalone device. A power regulator 66 is operable to regulate the voltage from the battery 64 or the charging port 62 depending on the usage to the CPU 20 and all other electronic components.

The external connectivity module 80 is used to interface with other devices including industry-recognized protocols such as (but not limited to) Wi-Fi 82, HDMI, and USB 84.

Wi-Fi protocol 82 refers to the wireless radio device that adheres to the 802.11 standard Wireless Local Area Network standard set by the Wi-Fi Alliance™. It is used to interface with smart devices, laptops and or computers in general to provide external control interfaces when desired. It may also be used to transmit captured images wirelessly to such smart devices, laptops or computers. It may also be used to download data and firmware from other devices to provide software upgrades for the camera device 10.

The Universal Serial Bus (USB) refers to the port that adheres to the standards set by the Universal Serial Bus organization. It serves a similar function to the Wi-Fi device except a physical linkage is required. It may be used to power the camera device 10 from the external power supply 60. The memory unit 100 is used to store captured images, firmware and related information required for the execution of the camera's software.

External memory 102 may include volatile or non-volatile memory. An example of a volatile memory would be static RAM for storing intermediate data in the process of capturing and processing the captured image. In the case of non-volatile memory it may be removed and replaced by the user.

Alternatively, the non-volatile memory may be integrated with the external memory 102. The external memory 102 serves as the repository for all captured images. It may be used to store and upgrade the firmware on the camera devices. It may also be used to store user specific settings. The storage technology used depends on the state of storage technology suitable at time of manufacturing.

Flash memory 104 refers to non-volatile memory integrated to the motherboard of the device and is neither intended to be user removable nor replaceable. It serves as the repository for all firmware and software required for the operation of the camera, including user specific settings and dark frames captured by the camera for the dark library, for the purpose of noise reduction processes implemented by the camera.

Input/output device module 120 refers to the IO devices used to display and communicate between the camera and a user. It comprises touch screen 122, shutter button 124, and control buttons 126.

Touch screen 122 refers to the digital image display device that allows touch inputs to control the camera settings. It is used for the live preview and control of the camera settings.

Shutter button 124 refers to one or more buttons specifically intended for the triggering command to capture images for both still images and video capture. Control buttons 126 refers to all other buttons that may be implemented to assist the user in controlling the camera, powering on and off the camera but not limited to the listed applications.

The spatial sensor module 140 comprises devices used to, inter alia; assist the camera in assessing its spatial location for the purpose of assisting the camera user to point the camera at the desired astronomical objects. The spatial sensor module 140 comprises Global Positioning System (GPS) receiver 142, accelerometer 144, gyroscope 146 and magnetometer 148. GPS 142 refers to GPS receiver that makes use of man-made satellites to determine the coordinates of the camera 10 location. It will assist in finding the required longitude and latitude of the location the camera is used at to facilitate the determination of the declination and right ascension of the astronomical objects.

Accelerometer 144 refers to a device that measures proper acceleration as understood by a skilled person to refer to acceleration with actual movement of the physical object, as compared to static acceleration such as the gravitational pull of Earth 9.81 ms⁻² on the device, it enables the camera 10 to provide feedback to the CPU 20 to reflect on the screen the direction the camera is pointed at responsively.

Gyroscope 146 refers to the device used to measure the orientation of the device to provide feedback to the CPU 20 to reflect on the screen to the user, the direction the camera is pointed at responsively.

Magnetometer 148 refers to the device that measures the magnetic field of the surrounding environment; acting as a form of compass device to indicate to the user the direction he is pointing the camera at.

The CPU 20 may comprise peripheral support devices. The CPU 20 is operable to coordinate the input from the various modules 40, 60, 80, 100, 120 and 140 to provide the overall functionality of the camera 10, including but not limited to controlling imaging sensor hardware, pre-processing captured images in RAW data format into compressed formats, virtualizing star atlas and providing information from the imaging sensor to the touch screen. The CPU 20 may comprise a real time clock (RTC) 22 for the necessary calculation of clock cycles and other supporting devices. The RTC 22 is further operable to keep track of real time (time in the real world) even when the primary battery in the camera is removed. In this regard, the RTC 22 may be powered by an independent battery source.

The camera and components may be integrated and compacted so as to achieve a small form factor. A small form factor may be achieved via the use of smaller image sensor 48 relative to or compared with mirror less cameras and digital single-lens reflex cameras (DSLRs). The lens can be smaller to provide an image circle sufficient to cover the entire imaging sensor.

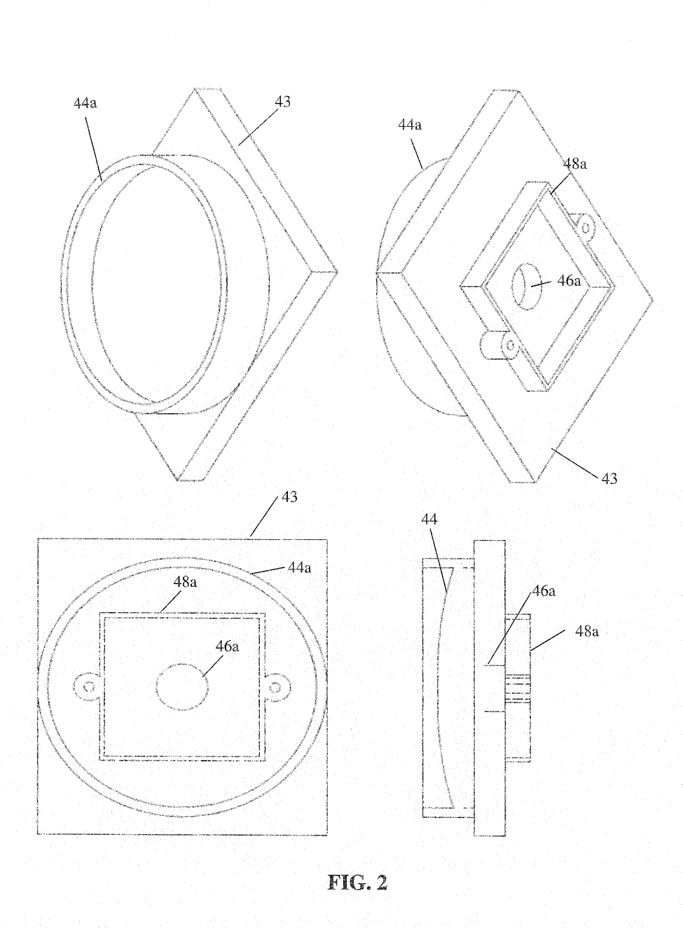

FIG. 2 illustrates an example of the arrangement of a spectral (sensor) filter 46 and the focal reducer 44. The focal reducer 44 is mounted on a circular mount 44a, which is stacked on top of a base plate 43, the base plate 43 having a slot 46a adapted for receiving the spectral filter 46. An image sensor holder 48a is arranged such that the image sensor holder 48a and the circular mount 44a sandwiches the base plate 43. The image sensor holder 48a is shaped and sized to receive the image sensor 48. Once arranged, the focal reducer 44, spectral filter 46 are aligned with the image sensor 48 such that the focal reducer 44 concentrate light to the imaging sensor 48 and any unwanted radiation is filtered by the filter 46. The spectral filter 46 may be replaceable. Compared to DSLRs, the thickness of the camera body is not constrained by the need to accommodate a physical structure of a mirror box. The flange distance, between the lens and sensor, is shorter thus the camera can be made thinner. As a comparison, the flange distance for a mirrorless mount, such as for example the Sony E is around 18 millimetres (mm), flange distance for DSLR is approximately 40 mm.

The above arrangement also negates the need for a separate computer. In particular, a separate computer is not required because the CPU is built into the camera itself. Instead of carrying a full sized computer/laptop of phone/tablet, the camera is functional as an independent unit.

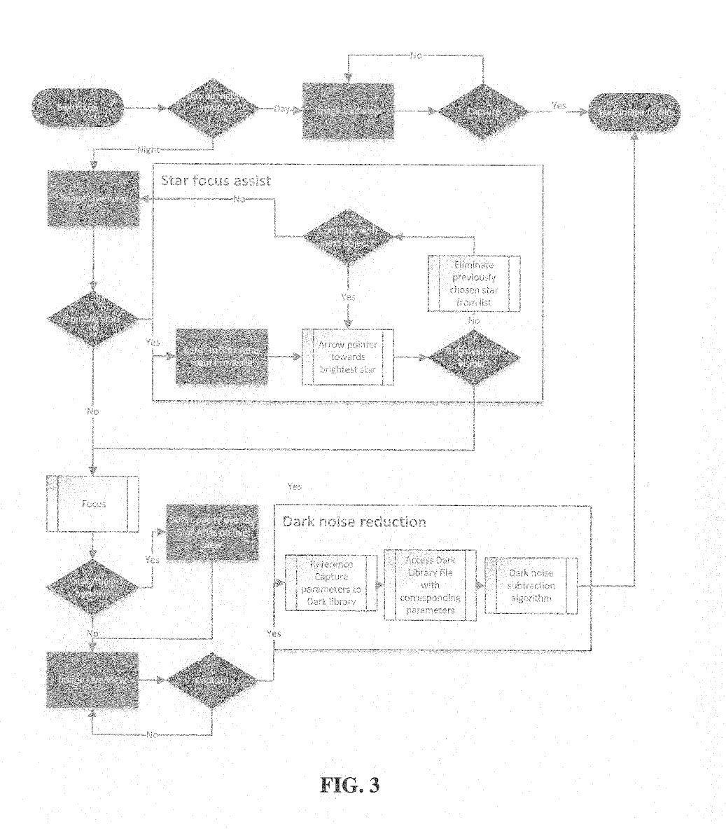

Referring now to FIG. 3, the system 10 will be described in the context of its operation in obtaining and capturing images; as well as functions which could be implemented as software installed within the memory unit 100 of the camera.

When a user switches on the image capturing apparatus 10 (e.g. a camera), the camera detects if it is daytime or night time. If it is determined to be daytime (or day mode is set), the user is brought to an image live view and there will be no software focus assist for pointing the camera to a bright object (hereinafter referred to as ‘point to bright object to focus’. A captured image will be captured (should the user choose to) and saved to file. The camera 10 may comprise an ‘image live preview’ function which is displayed on a user interface, e.g. a LCD screen for example, to assist the user in focusing and capturing the image. In addition to the ‘point to bright object to focus’ as a form of software focus assist, other types of software focus include but are not limited to: focus peak or other forms of edge or contrast detect software for assisting users in focusing the camera optics. Preferably, the chromatic aberration of the preview image may be used to determine if the optical lens 42 are in focus. Based on the presence of green or purple fringing of the bright object, it can be determined if the focus of optical lens 42 need to be adjusted further or closer respectively.

If the camera detects it is night time (or that night mode is set), a software focus will be activated and operable to assist the user to point the camera at bright objects, such as a star, with subsequent focusing and capturing of image.

The focus assist software function first requires the user to point to a general direction where the desired object to be captured is located in, e.g. the object is a star or planet visible on the night sky. The focus assist function is then operable to focus on the object to be captured while eliminating the other objects via an iterative process. The iterative process may be encoded in a form of software codes which can be written to evaluate objects above the horizon by a reasonable degree, for example, thirty degrees above the horizon to suggest to the user to point at for focusing. If the object is obstructed or otherwise not visible, a button can be pressed to suggest the next brightest object.

Once the desired object for image capturing is located, the camera is operable to focus on the desired object for image capture. Should an overlay be required to locate the bright object, a 50% opacity or other percentages of opacity overlay may be applied. Should a close-up zoom of the bright object be required to accurately determine focus, a zoomed-in section (‘crop’) of the preview image may be applied. To compensate for possible movement of the camera during focusing, dynamic tracking algorithms may be applied to ensure that the bright object is always in view in the zoomed-in section of the preview image, by tracking the brightest object in the preview image. Once the image is captured, it is sent for further processing to remove dark noise. The dark noise reduction function comprises at least one dark library.

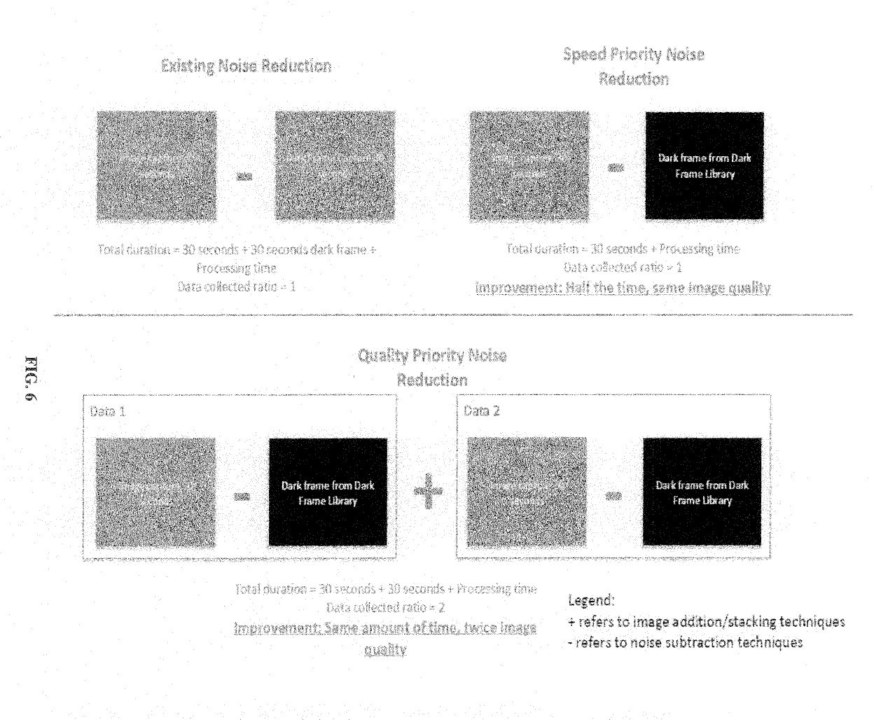

The dark library is a database comprising a library of dark noise images calibrated for specific image capturing devices/apparatus, settings and environmental conditions for dark noise subtraction. Non exhaustive examples of such environmental conditions include duration of capture (e.g. 30 seconds or 60 seconds) or sensor temperature (e.g. 30 or 40 degrees Celsius), etc. The dark library database would save time required at the point of capture as compared to prior art cameras which require another image (known as dark frames, to be captured). Dark noise libraries allow noise reduction algorithms to be implemented without the need to capture dark frames (i.e. dark frames are images with the similar or same exposure settings as the intended image, without exposing the imaging sensor to light) for noise reduction purposes after every image is captured. This shortens the total time to capture a long exposure image. With dark noise libraries, the camera does not have to be exposed twice, once for the final image and once for the dark frame (see FIG. 6a). The processor simply retrieve the dark noise image based on the parameters such as specific image capturing devices/apparatus, settings and environmental conditions as highlighted earlier.

In some embodiments, instead of shortening the total time to capture a long exposure image, multiple noise-reduced images (having a first round of noise reduction based on utilizing the dark library) may be combined (super-imposed) into one resultant image to further remove noise (see FIG. 6b). The combination of images may be based on an ‘add and average’ technique for reducing noise based on the eliminating of random noises.

As described, the image capturing apparatus 10 comprises built in focal reducers 44. The built in focal reducers 44 allows the invention to achieve very high intensity of light or focal ratio which allows a reduction in gain or exposure length or both which improves image quality by reducing noise in the final captured image.

The GPS overlay of star charts on the invention's live preview allows users to easily identify stars or other celestial objects easily at the point of capture to ensure proper framing of the objects users want to capture. An example of such star chart/map is the Google Sky Maps™.

The camera further comprises software installed thereon for implementing a ‘point to bright object to focus’ function. This ‘point to bright object to focus’ function allows users to quickly identify and locate bright objects to focus their lens 42. It is to be appreciated that existing cameras do not have this feature and focusing is based on the knowledge of the users to identify bright objects to focus their optics on.

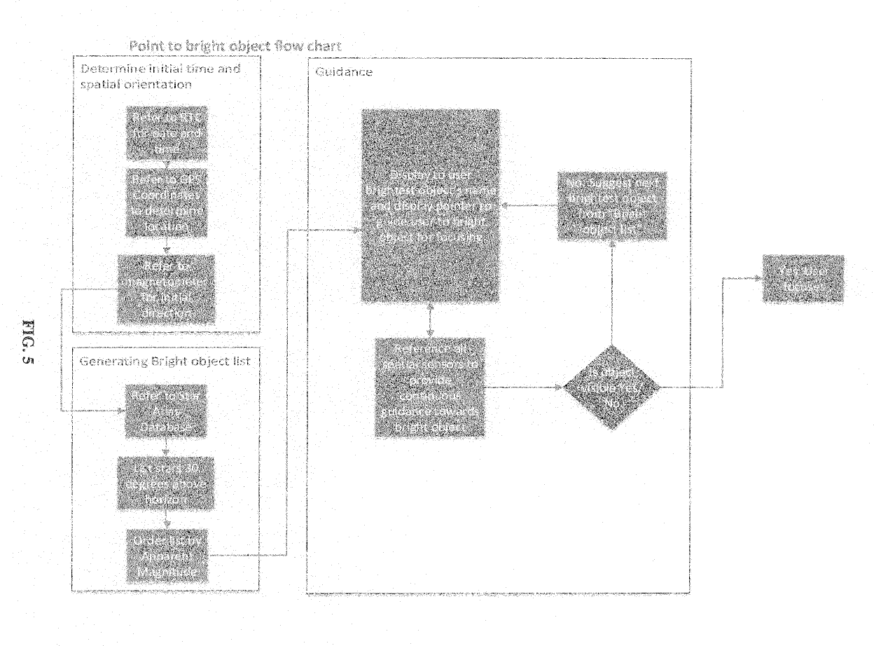

An example of the ‘point to bright object to focus’ algorithm is illustrated in FIG. 5. The algorithm comprises three sub-functions or logic steps for:—

i. determining time and spatial orientation;

ii. generating bright object list; and

iii. guidance.

The ‘Determining time and spatial orientation’ sub-function is used to determine at least three parameters for purpose of identifying one or more bright objects. The at least three parameters may comprise a reference to the real time clock (RTC) for date and time; reference to GPS coordinates to determine location; and a reference to magnetometer for initial direction. It is to be appreciated that the at least three parameters may further include the GPS for determining data and time, and other sensors including accelerometer and gyroscope.

Upon obtaining the three parameters, a reference to star atlas database is made to identify objects or ‘stars’ at any inclination above horizon where the objects to be captured for imaging is unhindered (for example thirty degrees above horizon) and placing them in a list (known as the ‘bright object list’); and ordering the list by a criterion. The criterion may be for example, the apparent magnitude of the brightness of the object.

Upon ordering the list comprising at least one bright object, the ‘Guidance’ function then display to the user the brightest object's name and display a pointer to guide the user to the brightest object for focusing. To assist the user, the spatial sensors 140 may be utilized or referenced to provide continuous guidance towards the bright object for identification. If the object is identified to be visible, the user would then operate the lens to focus on the object, else the next brightest object in the ‘bright object list’ is selected and suggested to be displayed to the user.

The star atlas or star chart may preferably be an image overlay which may be switched on or off in conjunction with the ‘point to bright object to focus’ function. Depending on a user's preference, he may choose to switch on the GPS overlay function in conjunction with the ‘point to bright object to focus’ function if it assists him in locating the desired celestial object, the desired celestial object's image is to be captured, or to switch off the ‘point to bright object to focus’ function if it causes distraction.

It is to be appreciated that the sub-function for determining time and spatial orientation run in the background and may continuously be updated depending on where the user is pointing the lens of the camera 10 towards. The generation of bright object(s) list; and guidance sub-functions may be updated once a change on the time and spatial orientation sub-function is detected.

As mentioned, the camera 10 may include interchangeable sensor filter 46. Compared with prior art cameras that comprise fixed filters over their sensors, the prior art cameras may not be ideal for more advanced astronomy imaging. The built in infrared cut filter blocks out certain wavelengths such as H-Alpha which is important for astronomy imaging. By making the filter user changeable the camera 10 can be customised for the imaging requirements by more advanced users. Filters 46 to suppress light pollution can also be easily fitted to allow astronomy imaging in light polluted locations. Software could be implemented to match brand specified filters to correct for the difference in the spectral response of the sensor created by the different filters. Users using existing cameras with 3rd party astronomy imaging add-ons will require advanced knowledge to correct for these imaging artifacts. The camera 10 may further comprise variable intervalometer. Although existing cameras may feature built-in intervalometers, standard intervalometers allow for constant interval capturing of images. Variable intervalometer allow users to change the capture interval for creative purposes with one setting without constantly re-programming the camera. For example an all day time lapse from night till day can be completed with the most ideal frame rates for each situation. Celestial objects take a long time to show apparent movement, therefore in the first 8 hours of capture, users may desire a longer interval to show the movement in a time lapse. However, upon day break, day time objects such as moving crowds may form in the day and a shorter interval may be required to ensure that people do not appear or seem to appear and reappear (teleport) from frame to frame which may occur when using longer intervals suitable for the night time. A variable intervalometer allows a set and forget mode that can be pre-programmed for variable conditions depending on the time of the day, instead of requiring reprogramming at every juncture. Field testing conducted allows a user to generate standard profiles for intervals. The non-volatile memory allows users to generate their own profiles and store those as presets (similar to storage of dark frames in the dark noise library). The storage of presets reduces the trouble of documenting settings and implementing the settings every time a time lapse is taken. A gradient of interval from long to short or vice versa can be set, to prevent abrupt transition from the night scene to the day scene. In addition, a variable intervalometer would achieve the advantage of relative ease to take time lapsed pictures into videos, because of the following:—
Typical time lapse option on existing cameras allows a user to choose a frame rate e.g. twenty-four (24) frames per second (FPS) and it will fit the number of captured frames into that frame rate for playback. To achieve transition from astronomy time lapse's slow interval to a more rapid interval using prior art cameras, users will have to modify the playback frame rate for the “daytime time lapse” to play back at a faster rate for it to give the impression that the rate of movements/activity in the time lapse has increased. Alternatively they will have to shorten the capture interval to make the activity appear faster which what the variable intervalometer is able to achieve the effect.

The arrangement of the image capturing device 10 further achieves the following advantages:—
Photos/videos may be stored in thumb-drive via the USB 84 or external flash memory 104. It is to be appreciated that the storage medium of storage may be any other types of storage media suitable for storing the photos/videos as known to a skilled person in the art.
Processing will be completed in the camera 10 as a standalone unit as compared to the prior art system where there is a need to extract raw image data and processing it on separate and/or independent computer software via image processing tools.
A star map overlay may be included to help a user/photographer locate the stars and constellation easier so that they have a better idea what the camera is pointing at. Built in focal reducers 44 intensify the light collected by the lens 42 onto the sensor 48. This allows the camera 10 to achieve the same exposure with a shorter shutter speed. It also allows a faster refresh rate of the screen as a result of the shorter shutter speed, which improves focusing speed on stars as the user gets more real time feedback on their adjustments to the focusing on the lens.
The star map overlay, which is a map of the sky, over the live preview of what the sensor is capturing, allows users to easily identify what they would be capturing in the frame in real time. Users operating existing cameras would not know which stars they are pointing at unless they have prior astronomy knowledge or use a separate device to refer to a star atlas.
Point to bright objects to focus guides the user to the brightest objects in the sky to allow the camera to be focused more effectively. As the stars are at infinity with respect to the resolution of the camera and lens 42, focusing on any stars would allow for a sharp image across the sky. Pointing at a brighter star will allow the camera to show details of the star for focusing to infinity at a shorter exposure rate, this allows better refresh rate of the live preview screen to allow more responsive focusing of the camera for astronomy use.
Interchangeable sensor filters allows the use of special astronomy filters such as H-Alpha bandwidth, O-III bandwidth, Light pollution filter and so on, to be attached over the sensor. Attaching the filter over the sensor allows a much smaller filter to be used, creating a more affordable and portable solution to placing the filter over the front of the imaging objective. The filters allow imaging for special astronomical objects or imaging whilst operating from a light polluted region which existing cameras would not typically be able to capture.
Variable intervalometer allows variable capture intervals to be set, this allows the user to find creative ways to compose time-lapse image captures using the image capturing device. Existing products only feature uniform intervalometer where the capture intervals are kept constant and would have to be manually updated from point to point in order to creatively speed up or slow down parts of the time-lapse process. In other words, the user or photographer can control the acceleration and deceleration of play back at different time interval.

Experiments are carried out on the image capturing device, an ASI 120MC™ astronomy camera from ZWO™ to test the feasibility of using a small ⅓″ image sensor for astronomy imaging.

The experiment proved the technical difficulty of capturing images of very dim objects using a small image sensor due to its poor sensitivity and noise performance, thus leading to non-ideal image quality. Poor noise performance at high sensitivity (ISO) also means that a lower ISO has to be selected and consequently, longer shutter speed is required to capture the detail of the astronomical object. It causes the refresh rate of the live preview function of the camera to be slower, causing difficulty in focusing the camera due to poor feedback, since every adjustment is reflected on screen only after approximately fifteen (15) seconds—when the camera has captured the frame to provide the user with the live preview.

The ⅓″ sensor faced constraints in increasing gain without losing image quality. At the maximum gain on the sensor setting, the image noise was significant. It is compounded by the fact that most astronomical objects are relatively dim. On a test setup 10-20 seconds exposure was required to see any astronomy objects on the screen. As the camera is focused using information on the screen, focusing was very difficult as the screen is only refreshed once every 10-20 seconds.

The images captured by the ⅓″ sensor had significant noise due to the high gain setting and the long exposure length.

The use of a built in focal reducer enables the focus of a larger image circle from the primary lens to a smaller area. As a result the light intensity increases, reducing the necessity to increase gain or exposure length or both. Such an arrangement is desirous to decrease the need to increase gain or increase exposure length to capture astronomical objects which lead to increased noise in the image.

Any noise in the captured images may be mitigated with the dark noise reduction library to further reduce/minimize the presence of noise in the images.

Focusing can also be achieved more easily as the screen refresh rate can be reduced. Image quality can be improved as gain or exposure length or both can be decreased.

Another solution primarily to address the difficulty of focusing was to use software combined with GPS data to guide the user to point the camera at a brighter object, for example Jupiter or Antares to focus the camera before commencing astronomical imaging. The brighter object will allow shorter exposure length, increasing the responsiveness of the screen refresh rate to allow better feedback for user manual focusing of the lens.

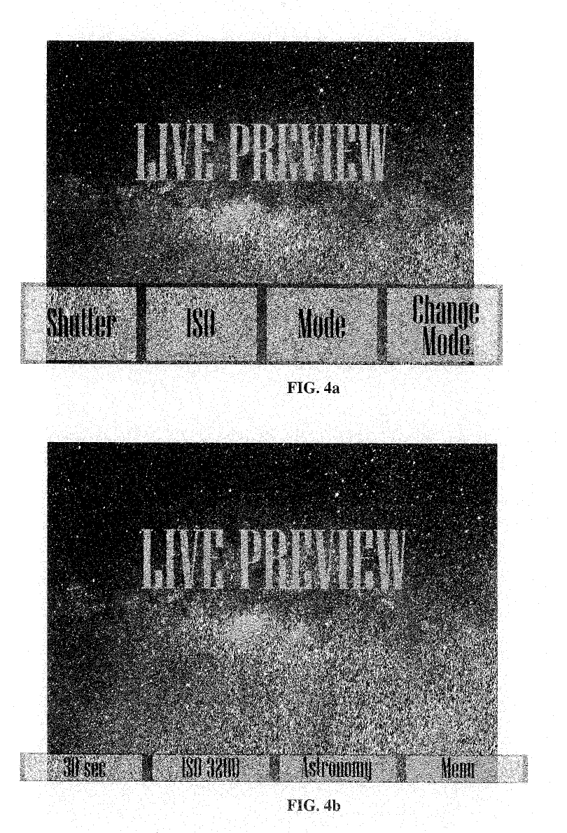

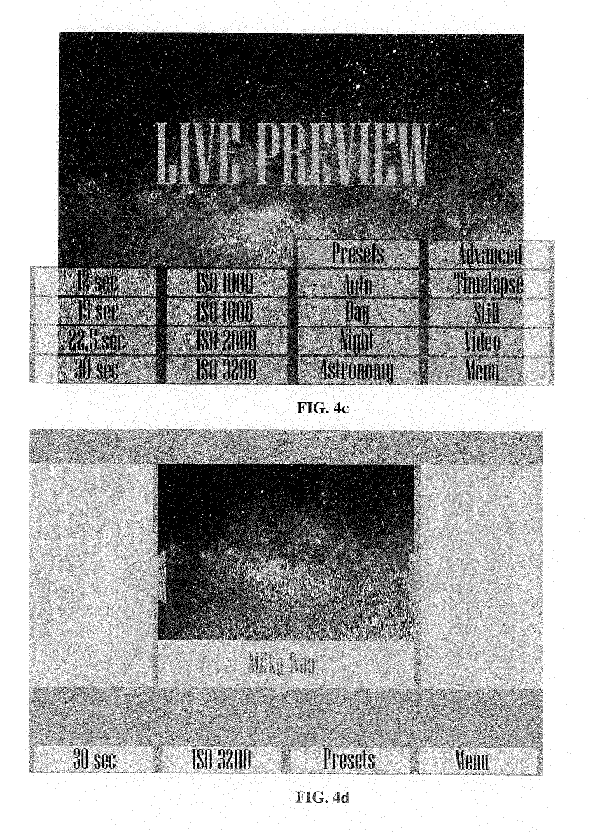

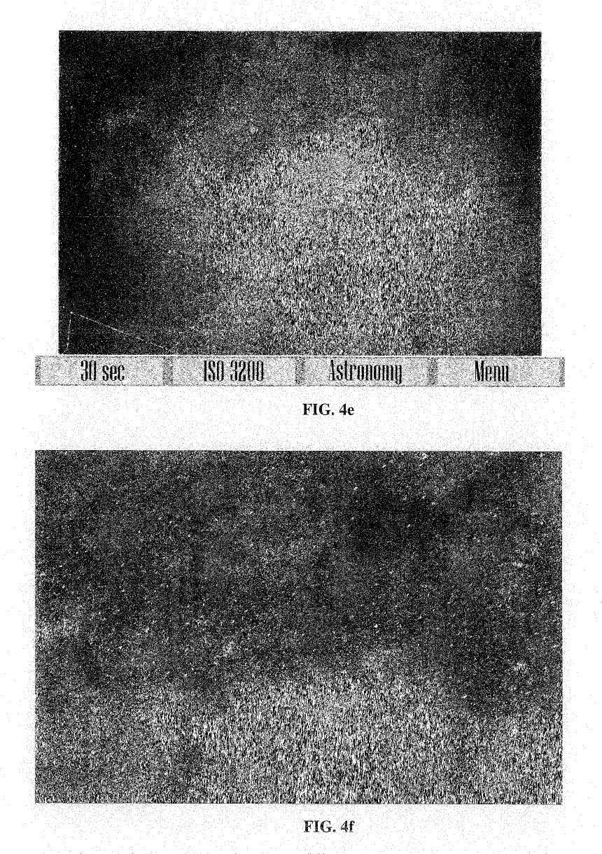

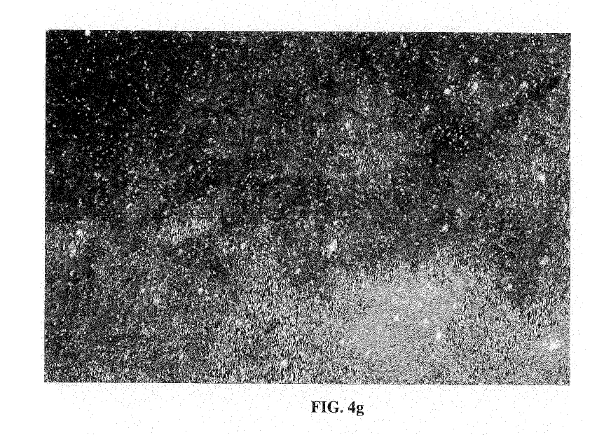

As illustrated, FIG. 4a is an example of the Camera User Interface (UI) illustration of the layout; FIG. 4b shows the camera UI with a user point of view when camera is operational; FIG. 4c shows the camera UI with a user point of view when bottom row buttons are clicked—a scrollable menu is displayed for selecting the settings required; FIG. 4d shows a selection menu for preset (other presets not defined yet but will include Solar, Lunar, Deep Sky Objects etc.) Presets will set the capture profile and post processing profile ideal for the capture of these objects. Minor adjustments of settings and manual override will still be available to users; FIG. 4e shows an example of how a star atlas will overlay on live preview (simulated. Live preview will not have the clarity of a captured image); FIG. 4f shows an exemplary DSLR image with good noise performance, taken with a Nikon D800E cropped field of view from 24 mm lens (with approximately 84 degrees field of view). FIG. 4g shows an image from ⅓ inch sensor ZWO 120MC cropped field of view with 3.5 mm lens (with approximately 84 degrees field of view)

It is to be understood that the above embodiments have been provided only by way of exemplification of this invention, and that further modifications and improvements thereto, as would be apparent to persons skilled in the relevant art, are deemed to fall within the broad scope and ambit of the present invention described herein. In particular, it is to be appreciated that features from various embodiment(s) may be combined to form one or more additional embodiments. Further, the following are non-exhaustive examples of features that may be combined with the described embodiments to form further embodiments that falls within the scope of the invention:—
Apart from astronomy imaging, the image capturing apparatus can still be used as a powerful compact camera for day time imaging, for example as a travel camera.
Long range surveillance imaging—with the focal reducer removed, a crop factor of about 6.3× to 7.0× is calculated. By attaching a standard 50 mm lens, it has the equivalent field of view of a 350 mm telephoto lens while still maintaining a compact form factor.
While the software focus assist function is able to assist a user to point to a bright object or further focus the optical lens 42, it is to be appreciated that the focus assist information may further be utilized to direct the user to move from his position in order to achieve a better focus of the optical lens.

1. An image capturing apparatus comprising:
an optical lens operable to focus incoming light;
a focal reducer arranged to receive focused incoming light from the optical lens and concentrate the focused incoming light onto an image sensor;
a processes in data communication with the image sensor to process the concentrated light to form an image;
wherein the processor comprises a noise reduction module to process the formed image with at least one pre-captured dark noise image for dark noise reduction, the at least one pre-captured dark noise image selected from a plurality of dark noise images.

2. The apparatus according to claim 1, wherein the focal reducer is integrated with the optical lens and the image sensor.

3. The apparatus according to claim 1 or 2, wherein the intensity of the concentrated focused incoming light is determined by a focal ratio of the optical lens and the focal ratio allows a reduction in gain and/or exposure length.

4. The apparatus according to any one of the preceding claims wherein the image sensor comprises an array of pixel sensors.

5. The apparatus according to the claim 4 wherein the array of pixel sensors comprises a charge-coupled device (CCD) or a complementary metal-oxide semiconductor (CMOS) sensor.

6. The apparatus according to any one of the preceding claims wherein the processor is in data communication with a database to receive and store the image.

7. The apparatus according to any one of the preceding claims further comprising a sensor filter, wherein the sensor filter is operable to filter the incoming light.

8. The apparatus according to any one of the preceding claims wherein the noise reduction module comprises a database of a plurality of pre-captured dark noise images.

9. The apparatus according to claim 8, wherein the noise reduction comprises at least one pre-captured dark noise image having similar exposure settings as the image.

10. The apparatus according to claim 9, wherein the similar exposure settings include environmental settings.

11. The apparatus according to claim 10, wherein the environmental settings include duration of capture and sensor temperature.

12. The apparatus according to any one of claims 8 to 11, wherein a plurality of noise-reduced images are combined into one resultant image to further reduce noise.

13. The apparatus according to any one of claims 1 to 7, wherein the noise reduction module is operable to combine a plurality of images.

14. The apparatus according to any one of the preceding claims, wherein the processor further comprises an image live view module operable to display the live image and assist the user in the focusing and capturing of image.

15. The apparatus according to claim 14, wherein the image live view function further comprises of a built-in display screen in data communication with the processor.

16. The apparatus according to claim 14 or 15, wherein a star atlas chart is operable to be overlaid over the live image to assist the user identify the objects the apparatus is pointing at, in real time.

17. The apparatus according to any one of claims 14 to 16, wherein the built-in display screen is a touch screen operable to allow touch inputs to control image capturing settings.

18. The apparatus according to any one of the preceding claims further comprising a plurality of spatial sensors coupled to the processor to provide location input, wherein each spatial sensor is operable to assist a user point the apparatus at a desired object for image capture.

19. The apparatus according to the preceding claim, wherein the spatial sensor comprises at least one of the following:—a Global Positioning System (GPS), accelerometer, gyroscope and magnetometer.

20. The apparatus according to any one of claims 1 to 18, wherein the spatial sensor comprises a Global Positioning System (GPS), an accelerometer, and a magnetometer.

21. The apparatus according to any one of claims 14 to 20, the processor further comprises a bright object focus module operable to assist the user quickly identify, locate and focus on bright objects.

22. The apparatus according to the preceding claim wherein the bright object focus module comprises the following functions:—
(i) determine time and spatial orientation function;
(ii) generate a bright object list function; and
(iii) a guidance function.

23. The apparatus according to the preceding claim wherein the determine time and spatial orientation function is operable to determine at least three parameters for the purpose of identifying one or more bright objects, the at least three parameters comprises a reference to the real time clock (RTC) for date and time, reference to GPS coordinates to determine location, date and time; and a reference to a plurality of spatial sensor for direction.

24. The apparatus according to claim 22 wherein the generate bright object list function is operable to use the at least three parameters and refer to a star atlas database to identify objects or stars above horizon and placing them in a bright object list.

25. The apparatus according to claim 24, wherein the bright object list can be sorted according to at least one criterion.

26. The apparatus according to claim 22 wherein the guidance function is operable to display the bright object list and display a pointer to guide the user to select a bright object on the list.

27. The apparatus according to any one of the preceding claims further comprises a variable intervalometer in data communication with the processor, wherein the intervalometer is operable to assist a user capture time-lapse images with variable time intervals between adjacent images; and the time intervals are pre-programmable.

28. The apparatus according to any one of the preceding claims wherein an external connectivity module is coupled to the processor, the external connectivity module operable to interface with other electronic devices.

29. The apparatus according to claim 28 wherein the external connectivity module uses the Wi-Fi protocol or the Universal Serial Bus (USB).

30. A method for capturing image comprising the steps of:—
(i) focusing incoming light using an optical lens;
(ii) concentrating the focused incoming light onto an image sensor using a focal reducer;
(iii) processing the focused incoming light using a processor to form an image;
wherein the processor is further operable to perform the step of subtracting noise from the formed image using a noise reduction module and process the formed image with at least one pre-captured dark noise image for dark noise reduction, the at least one pre-captured dark noise image selected from a plurality of dark noise images.

31. The method according to claim 30, wherein the noise reduction module comprises a database of dark noise images pre-captured and stored in the database.

32. The method according to claim 31, further comprising the step of selecting a dark noise image having similar exposure settings as the image and pixel before subtracting the noise from the image.

33. The method according to claim 32, wherein the similar exposure settings include environmental settings.

34. The method according to claim 33, wherein the environmental settings include duration of capture and sensor temperature.

35. The method according to any one of claims 31 to 34, wherein a plurality of noise-reduced images are combined into one resultant image to further reduce noise.

36. The method according to claim 30, wherein the noise reduction module is operable to combine a plurality of images.

37. An image capturing apparatus comprising:
an optical lens operable to focus incoming light;
an image sensor to receive the focused incoming light;
a processer in data communication with the image sensor to process the focused light to form an image;
wherein the processor comprises a noise reduction module operable to remove noise from the image; and
wherein the noise reduction module comprises a database of a plurality of dark noise images pre-captured and stored in the database, the noise reduction module operable to process the formed image with at least one pre-captured dark noise image for dark noise reduction, the at least one pre-captured dark noise image selected from the plurality of dark noise images.

38. A method for capturing image comprising the steps of:—
(i) focusing incoming light using an optical lens;
(ii) receiving the focused incoming light using an image sensor;
(ii) processing the focused incoming light using a processor to form an image;
wherein the processor is further operable to perform the step of subtracting noise from the image using a noise reduction module; and
wherein the noise reduction module comprises a database of dark noise images pre-captured and stored in the database, the noise reduction module operable to process the formed image with at least one pre-captured dark noise image for dark noise reduction, the at least one pre-captured dark noise image selected from the plurality of dark noise images.
